(19) United States
(12) Patent Application Publication
(10) Pub. No.: US 2013/0213381 A1
(43) Pub. Date: Aug. 22, 2013

(54) Adjustable Hitch Grill

(71) Applicants: Daniel Schul, Tallahassee, FL (US); Melford Sims, Crawfordville, FL (US)

(72) Inventors: Daniel Schul, Tallahassee, FL (US); Melford Sims, Crawfordville, FL (US)

(21) Appl. No.: 13/399,451

(22) Filed: Feb. 17, 2012

(51) Int. Cl. A47J 37/07

(52) U.S. Cl. 126/25 R

(57) ABSTRACT

An adjustable hitch grill for food preparation comprising: a drum portion; a vertical arm attached to the drum portion; a horizontal arm attached to the vertical arm at a first end of the horizontal arm, where the horizontal arm attaches to a hitch at a second end of the horizontal arm; a plurality of vertical holes along the vertical arm, where the vertical holes provide a vertical means of adjustment; and a plurality of horizontal holes along the horizontal arm, where the horizontal holes provide a horizontal means of adjustment. The drum portion includes an opening and lid, where the lid covers the opening.

### BACKGROUND OF THE INVENTION

1. Field of Invention The field of invention relates to an adjustable-hitch attachable grill for food preparation.

2. Description of Related Art

Grilling is a common form of food preparation where heat is applied to food from below and the food is placed upon a wire grid that allows a transfer to heat onto the food on the grid. Usually the heat source is in the form of charcoal, gas or in some cases wood. Many people enjoy grilling as an alternative to food preparation especially when preparing meat. Grilled meats will normally have reduced fat levels due to the dripping of fat from the meat and therefore providing a healthy alternative to cooking in oils or frying in fat. Grilling is also a popular summer or warm-weather activity for many individuals. Further individuals use grills at certain sporting events as a pregame activity such as tailgating.

Most grills are designed to be stationary or at least essentially within a stationary position. Various portable grills exist in the prior art of different sizes or shapes, where the grills are placed upon a frame that may include wheels or may convert to a smaller size for easy portable grilling. Consequently since a number of individuals may enjoy grilling in various conditions it is always a need for alternatives for portable grills. Portable grills allow individuals to enjoy grilling away from home at campsites, tailgating activities, extended road trips and other similar activities.

### SUMMARY OF THE INVENTION

The present invention relates to an adjustable hitch grill for food preparation comprising: a drum portion; a vertical arm attached to the drum portion; a horizontal arm attached to the vertical arm at a first end of the horizontal arm, where the horizontal arm attaches to a hitch at a second end of the horizontal arm; a plurality of vertical holes along the vertical arm, where the vertical holes provide a vertical means of adjustment; and a plurality of horizontal holes along the horizontal arm, where the horizontal holes provide a horizontal means of adjustment. The drum portion includes an opening and lid, where the lid covers the opening. The drum portion may further include a smoke stack, where the smoke stack enables of the emission smoke from the drum portion. The lid may include a handle. A grilling surface is also provided within the interior of the drum portion.

### BRIEF DESCRIPTION OF DRAWINGS

FIG. 1 depicts a top view of an adjustable hitch grill in accordance with the present invention.

FIG. 2 depicts a side view of the adjustable hitch grill in accordance with the present invention.

FIG. 3 depicts a front view of the adjustable hitch grill in accordance with the present invention.

### DETAILED DESCRIPTION

The present invention provides an adjustable hitch grill used for food preparation. The adjustable hitch grill according to the present invention allows individuals to enjoy grilling at various sites and locations, where the grill may be attached to a hitch of a vehicle. The adjustable hitch grill according to the present invention includes a vertical and horizontal hitch arm that allows the grill to be attached to the hitch of a vehicle. The hitch grill according to the present invention is then adjusted to a proper position vertically and horizontally along each arm so that the user may easily utilize a grill for food preparation. The hitch arm that extends from the grill is collapsible for storage of the grill when not in use.

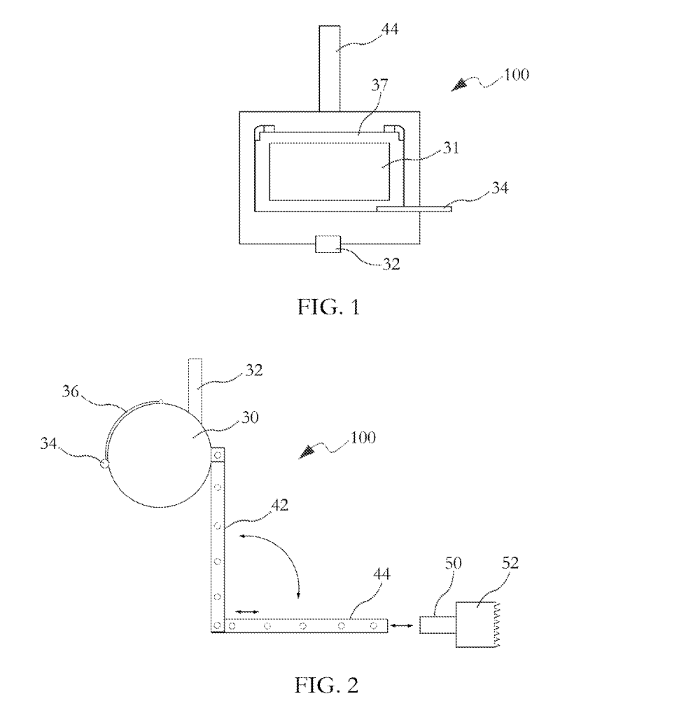

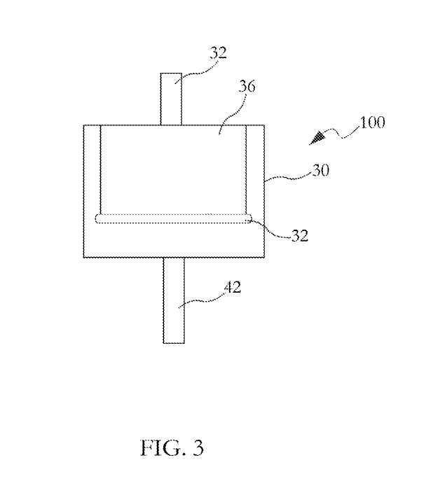

In reference to FIG. 1 a top view of an Adjustable Hitch Grill 100 according to the present invention is depicted. As depicted, the top view the Grill 100 is shown with the lid open so that a Grilling Surface 31 is shown. Surrounding the Grilling Surface 31 is a Lid Strip 37. This Lid Strip 37 allows for the placement of the lid in a closed position. The lid is depicted in a closed position in FIGS. 2 and 3 to follow. Extending from the Grill 100 is a horizontal Hitch Arm 44. The Hitch Arm 44 allows for the attachment of the grill assembly onto a hitch of a vehicle. Further seen in FIG. 1 is a Handle 34 that is used to open and close the lid that covers the Grill Surface Area 31.

In reference to FIG. 2, a side view of the Hitch Grill 100 is depicted. Within the side view the horizontal Hitch Arm 44 extends from a vertical Hitch Arm 42. A plurality of holes are provided along each arm to allow for the vertical and horizontal adjustment of the grill as needed and suited for use. The Horizontal Hitch Arm 44 attaches to a Hitch 50 as shown. Hitch 50 may extend from a Bumper 52 of a vehicle, not shown. A Grill 100 includes a drum portion or Body 30 that houses the grilling surface and the charcoals or wood that may be used as the combustion source for heating and cooking the food. The Handle 34 is shown as attached to a Lid 36. Ascending upwardly from the Drum 30 is a Smokestack 32. The Smokestack 32 allows for the emission of smoke and combustibles during the cooking process.

A front view of the Hitch Grill 100 is depicted in FIG. 3. The Hitch Grill 100 as shown in FIG. 2 includes the Drum Portion 30 that includes an opening, which is sealed by Lid 36. The Lid 36 may be hinged into place, which allows for the opening thereof through the use of the Handle 34. Also shown in FIG. 3 is the vertical Hitch Arm 42. The vertical Hitch Arm 42 allows for the vertical adjustment of the grill as needed by the user.

The adjustable hitch grill in accordance with the present invention allows individuals to enjoy grilling while camping, tailgating, hunting or fishing and provides a convenient grill with fire pit that may be easily transported in a vehicle. The L-shaped hitch arm that includes Arm 42 and Horizontal Arm 44 provides the means for the vertical and horizontal adjustment and positioning of the grill as suited for the user. The instant invention has been shown and described in what it considers to be the most practical and preferred embodiments. It is recognized, however, that departures may be made there from within the scope of the invention and that obvious modifications will occur to a person skilled in the art.

What is claimed is:

1. An adjustable hitch grill for food preparation comprising:
a. a drum portion;
b. a vertical arm attached to the drum portion;
c. a horizontal arm attached to the vertical arm at a first end of the horizontal arm, where the horizontal arm attaches to a hitch at a second end of the horizontal arm;
d. a plurality of vertical holes along the vertical arm, where the vertical holes provide a vertical means of adjustment; and
e. a plurality of horizontal holes along the horizontal arm, where the horizontal holes provide a horizontal means of adjustment.

2. The adjustable hitch grill according to claim 1, where the drum portion includes an opening and lid, where the lid covers the opening.

3. The adjustable hitch grill according to claim 1, where the drum portion further includes a smoke stack, where the smoke stack enables of the emission smoke from the drum portion.

4. The adjustable hitch grill according to claim 2, where the lid includes a handle.

5. The adjustable hitch grill according to claim 1, where the drum portion includes a grilling surface.
